(19) United States
(12) Patent Application Publication
(10) Pub. No.: US 2007/0101830 A1
(43) Pub. Date: May 10, 2007

(54) Leverage master carpenter manner

(76) Inventor: James J. Vacca III, Philadelphia, PA (US)

Correspondence Address: James J. Vacca III, 3807 Linden Ave., Philadelphia, PA, 19114, US

(21) Appl. No.: 11/588,749

(22) Filed: Oct. 27, 2006

Related U.S. Application Data
(60) Provisional application No. 60/730,942, filed on Oct. 28, 2005.

(51) Int. Cl. B25D 1/00

(52) U.S. Cl. 81/20

(57) ABSTRACT

A hammer with a conventional or extended handle and striking head, with an elongated curved claw having an enlarged top of handle housing in the form of a semi-circle (camel back) for the purpose of considerably increased leverage while prying different length common nails. This will allow completely carrying out the extraction process of the desired nail in one continuous motion.

### REFERENCE CITED

### U.S. Patent Documents

| | | | |
|---|---|---|---|
| 724,542 | Apr. 7, 1903 | Brownell | 254/26R |
| 1,089,234 | Mar. 3, 1914 | Leslie | |
| 1,531,014 | Mar. 24, 1925 | Maclure | |
| 1,550,405 | Aug. 18, 1925 | Williams | |
| 2,553,102 | May 15, 1951 | McLean | |
| 2,643,854 | Jun. 30, 1953 | Johnson | 254/27 |
| 2,657,903 | Nov. 03, 1953 | Johnson | 254/26E |
| 3,885,772 | May 27, 1975 | Balkus, Jr. | 254/26 |
| 4,216,808 | Aug. 12, 1980 | Royce | |
| 4,482,132 | Nov. 13, 1984 | Lamansky | |
| 5,159,858 | Nov. 03, 1992 | Gensen | |
| 5,249,776 | Oct. 05, 1993 | Johnson | |
| 5,622,352 | Apr. 22, 1997 | Swindoll | |
| 6,032,927 | Mar. 7, 2000 | Atkinson | |
| 6,866,247 B2 | Mar. 15, 2005 | Thompson | |

### BACKGROUND OF THE INVENTION

1. Field of the Invention

The present invention relates to hammers and more specifically pertains to a carpenter's claw hammer that significantly increased leverage during the nail extraction operation.

2. Description of the Prior Art

Existing patent hammers designed to facilitate the extraction of various length nails do so by utilizing more than one claw or adding several different devices to the current standard hammer. The result of these types of designs is problematic in that they require maintenance and are subject to breakage (examples cited but not limited to U.S. Pat. Nos. 5,249,776 3,885,772 2,657,903 2,553,102).

Most hammers today use a single claw opposite the striking head to aid in the removal of nails offering different degrees of operability. Carpenter hammers or straight claw hammers, for example, are well known to have difficulty removing long nails (10D, 12D, 16D, 20D); the extracting capability varies between 1 inch to 1½ inches until the hammers striking head reached the surface preventing further leverage from taking place, thereby leaving a large residual of the nail unextracted.

Occasionally, as a second step for nail prying, the claw is backed out of the nail and moved to a second claw or device (examples cited but not limited to U.S. Pat. Nos. 6,866,247 B2 6,032,927 5,622,352 5,159,858 4,482,132 1,550,405). Curved claw hammers have similar problems, although the curvature of the claw yields for extra extracting distance, it tends to force a bend in the nail and displacing the removal force sideways in the direction of the hammer causing increased friction resulting in leverage loss.

Commonly know hammers also have additional problems while removing long nails or using the claw as a prying tool. The fulcrum point is very low forcing the user to utilize a block of wood or some other material placed directly below the top of the hammer's handle housing in order to elevate the point of support in which the hammer pivots; therefore, increasing leverage allowing longer claw rotation. Although this technique is often utilized the hammers position may become unstable and may cause the hammer to slip and possible cause damage to the surface being worked on or even bodily harm.

In many cased a person utilizing a standard hammer while working on roofs or other jobs that require the user to climb a ladder or scaffolding conventional hammers lack the necessary leverage for the tack at hand.

Generally, this practice significantly compromised the users safety since in order to complete the task at hand the person using the equipment needs to often use both hands letting go of the ladder or scaffolding, thereby facing possible injury or even death as a result of a fall.

### SUMMARY OF THE INVENTION

A hammer having a conventional head or flat top portion, when used to extract nails of various lengths can not completely extract the nails before the nail binds or bends in the material from which it is being removed.

The present invention relates to claw hammers, specifically those designed to improve their prying ability in order to remove long nails of other surface- affixed materials. This invention provides increased leverage by elevating the point of support on which the hammer rotates while in use as a prying elongation of the tip of the hammer in the shape of a semi-circle or “camel back” depending on the prying elevation distance needed. In addition, the curvature and length of the claw are slightly larger than the conventional hammer.

The objective of the current invention is to provide a carpentry tool that delivers increased leverage and greater extraction capabilities while prying long nails or other materials and at the same time provides striking surface for hammering needs.

### BRIEF DESCRIPTION OF THE DRAWINGS

The elongated, ovalized head in FIG. 1 has an ovalized, provection which allows a vertical upward prying motion as shown in FIGS. 2, 3 and 4 with extremely increased leverage over a conventional hammer.

FIG. 1 also describes the elements of a traditional hammer other elements 1,2,3,4 and 5.

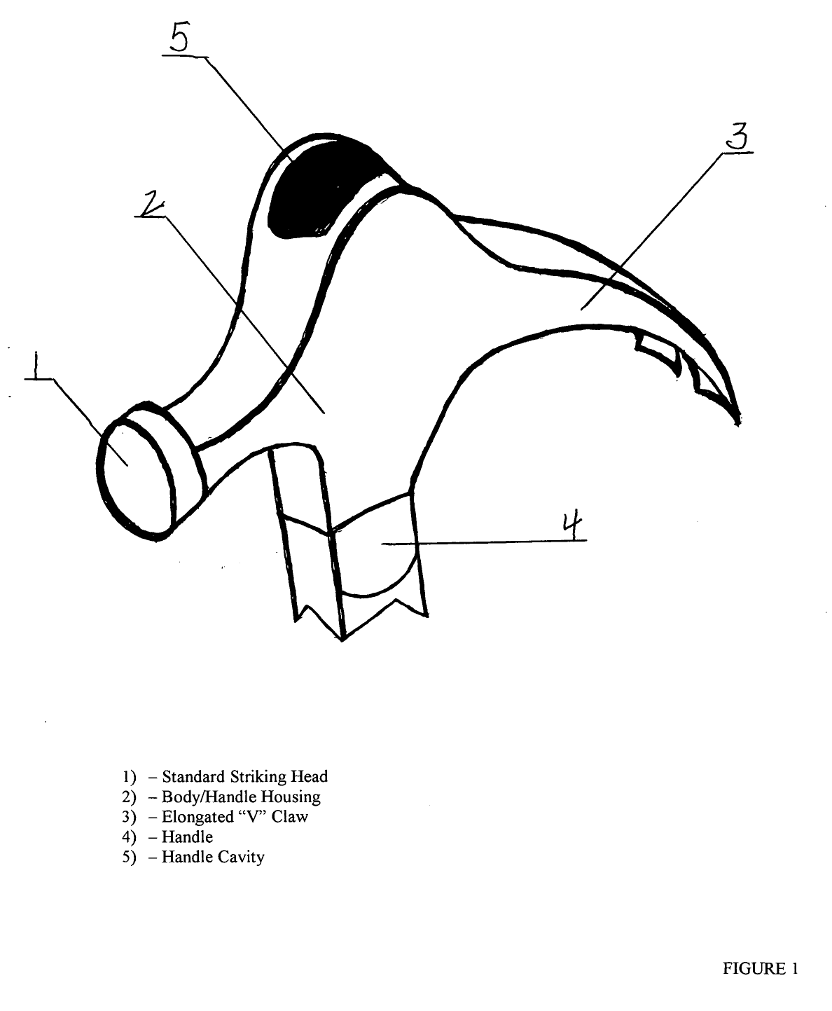

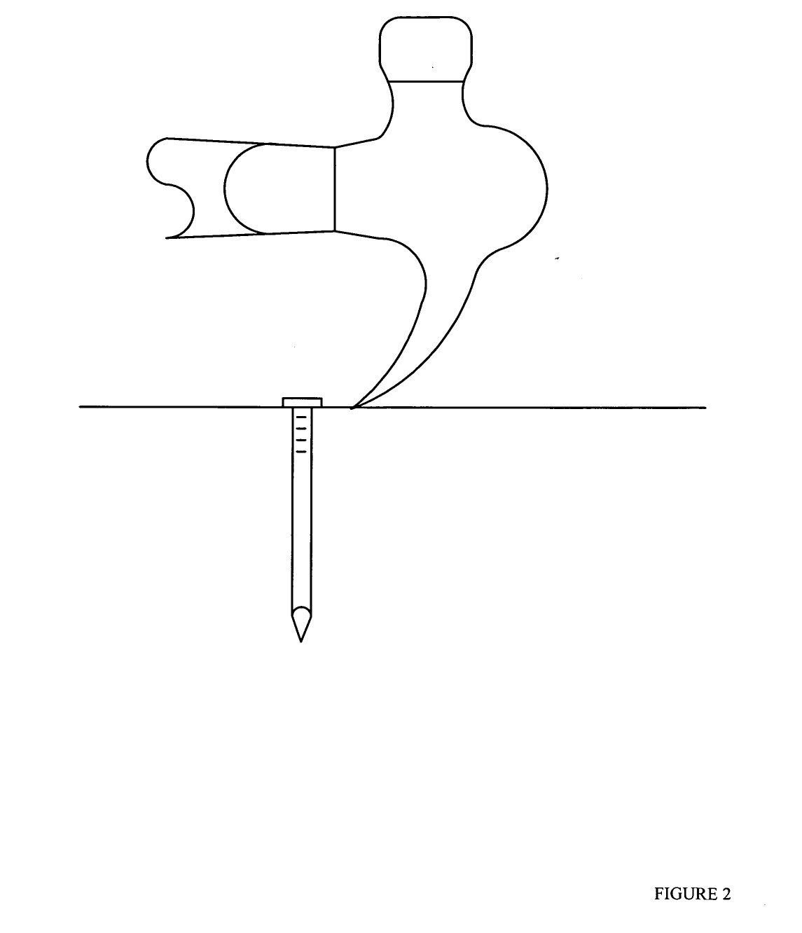

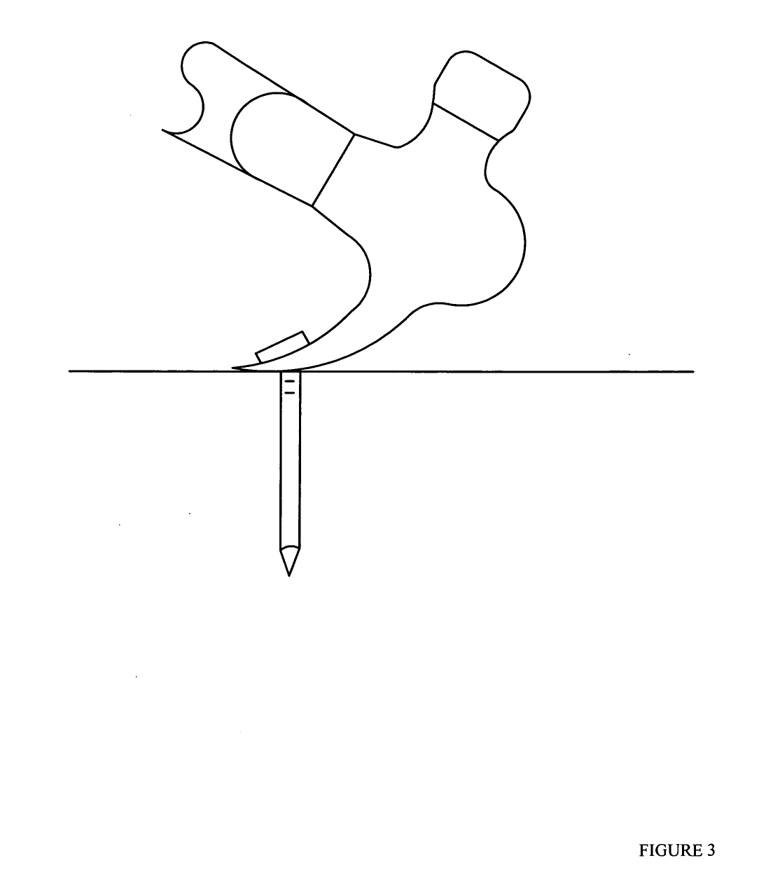

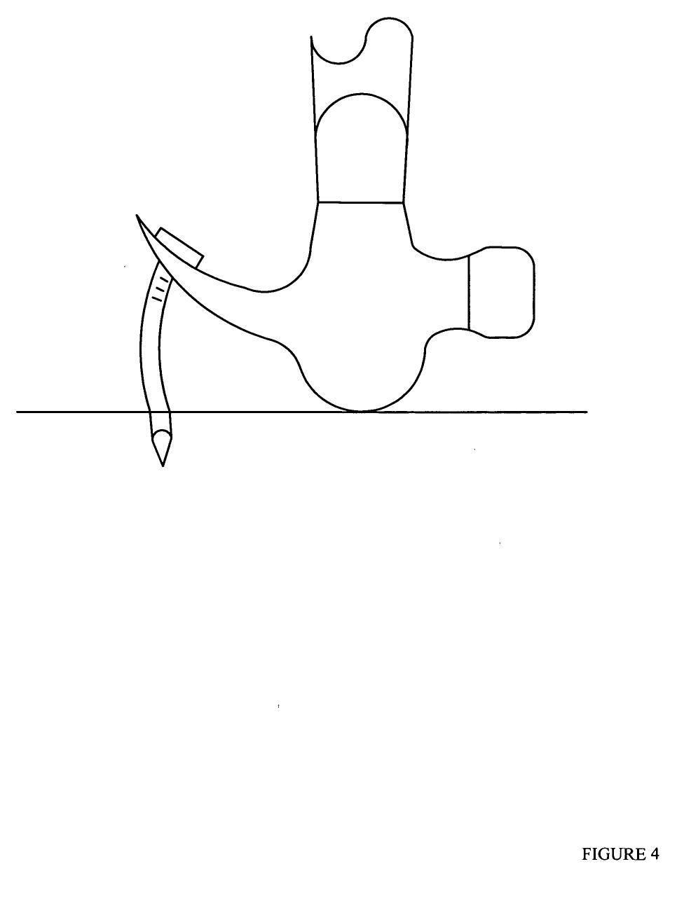

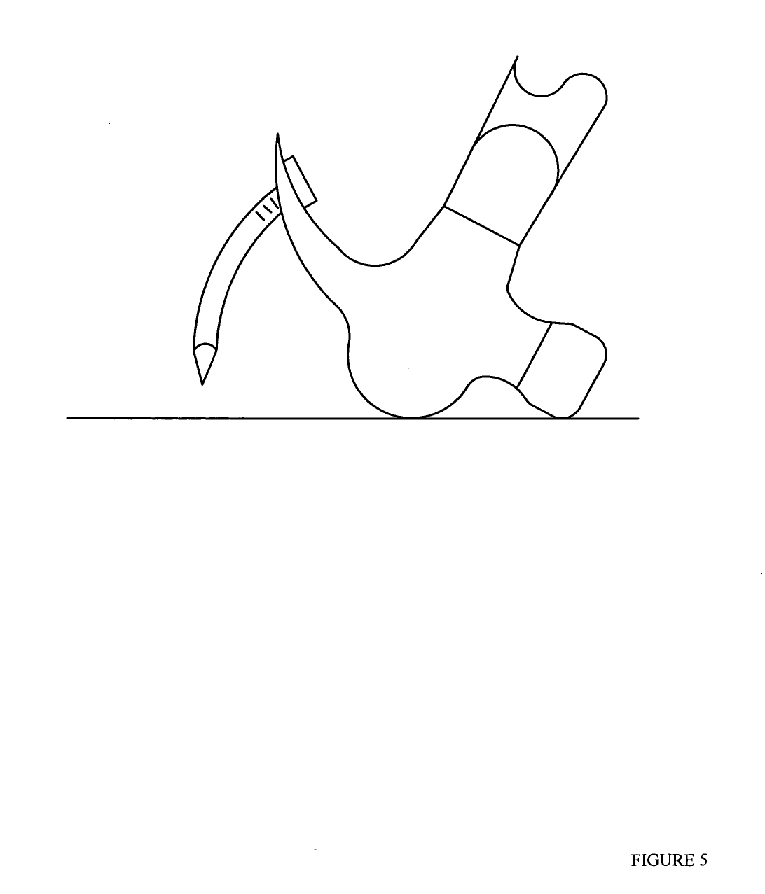

I claim:

1. The rounded, extended top on the leverage master carpenter hammer will completely extract nails of various lengths from that which it is being extracted in a clean, singular motion without any binding of bending occurring and can be used in embedding nails into material in the same manner of fashion as a traditional hammer.

2. The manufacture of the leverage master carpenter hammer can be modified to produce the elongation or “camel back” feature in a single mold of any variety of lengths and weights; therefore, there are no parts requiring maintenance making this a maintenance free tool.
